(19) United States
(12) Patent Application Publication
(10) Pub. No.: US 2016/0189075 A1
(43) Pub. Date: Jun. 30, 2016

(54) Process for Streamlining Job Plans, Tasks and Ancillary Components for a Work Management System

(71) Applicant: Derrick Tobias Babb, Miami, FL (US)

(72) Inventor: Derrick Tobias Babb, Miami, FL (US)

(21) Appl. No.: 14/876,663

(22) Filed: Oct. 6, 2015

Related U.S. Application Data
(60) Provisional application No. 62/071,975, filed on Oct. 6, 2014.

(51) Int. Cl. G06Q 10/06

(52) U.S. Cl. CPC G06Q 10/06316

(57) ABSTRACT

A process for streamlining job plans for a work management system using parameterized templates is presented. The parameterization of job tasks and any ancillary components allows job plans to be consolidated into job plan templates. Various job plan instances can then be configured using such a template, representing the various configurations of a class of asset. The advantage of this approach is reducing the volume of material that must be maintained for potentially mission critical, safety critical job plans. Furthermore, it allows for the generation of fine-grain job plans for the various subclasses of an asset. Ultimately, it enables an organization to shift focus towards developing the best possible job tasks, which are then reused to develop the best possible job plans.

### CROSS-REFERENCE TO RELATED APPLICATIONS

This application claims priority to provisional application No. 62/071,975, filed Oct. 6, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Various features described herein relate generally to job plans (also known as work plans) used in a work management system and more specifically to job plan streamlining.

Job plans are composed of job tasks and ancillary components, such as meters, task duration, nested job plans, lock outs, tag outs, required tools, etc. Job plans are used in conjunction with work orders to define the work that is to be performed within a work management system.

Conventional representations of job plans lend to little reuse of job tasks and ancillary components within or across job plans. No known technique addresses the reuse of repeating tasks that are nearly homogeneous.

As the complexity of job plans increases for an organization, maintenance costs increase due to the overall volume of plans, tasks and ancillary components. Furthermore, the overall effectiveness of leveraging a plan across multiple subclasses of an asset decreases due to the inclusion of irrelevant tasks and ancillary components necessary to cover all asset subclasses.

(Kay, 2012) deals with assigning parameters that act as constraints in selecting the appropriate people to action the tasks found in project plans.

(Carruth, 2011) deals with grouping tasks in a job plan. Grouping tasks is different than synthesizing a minimal job plan based upon the input of a plan containing recurring, closely related tasks.

(Cox, Janakiraman, Lu, & Salem, 2013) deals with the generation of tasks in real-time.

### SUMMARY OF THE INVENTION

The present invention is a process that streamlines job plans for application in a work management system. These job plans will incorporate job tasks that are nearly homogeneous but exhibit some variability. Tasks and any ancillary components of the tasks are formulated as parameterized templates that 1) reduce the volume of material that must be maintained and 2) enables the generation of asset-specific job plans tailored for asset subclasses as opposed to monolithic job plans for an asset class containing irrelevant tasks for asset subclasses.

### BRIEF DESCRIPTION OF THE DRAWINGS

FIG. 1 illustrates a workflow that embodies the invented process.

FIG. 2 illustrates a list of job plan imports.

FIG. 3 illustrates a job plan import with repeating task variations.

FIG. 4 illustrates a list of template parameters.

FIG. 5 illustrates a template parameter.

FIG. 6 illustrates a second template parameter.

FIG. 7 illustrates a third template parameter.

FIG. 8 illustrates a meter template prior to parameterization.

FIG. 9 illustrates a meter template with parameter placeholders.

FIG. 10 illustrates a meter template with parameters assigns to parameter placeholders.

FIG. 11 illustrates a meter template after consolidation.

FIG. 12 illustrates a list of job task templates that use a consolidated meter template.

FIG. 13 illustrates job task template prior to parameterization.

FIG. 14 illustrates a job task template with parameter placeholders.

FIG. 15 illustrates a job task template after consolidation.

FIG. 16 illustrates an unconsolidated job plan template.

FIG. 17 illustrates a consolidated job plan template.

FIG. 18 illustrates a job plan instance.

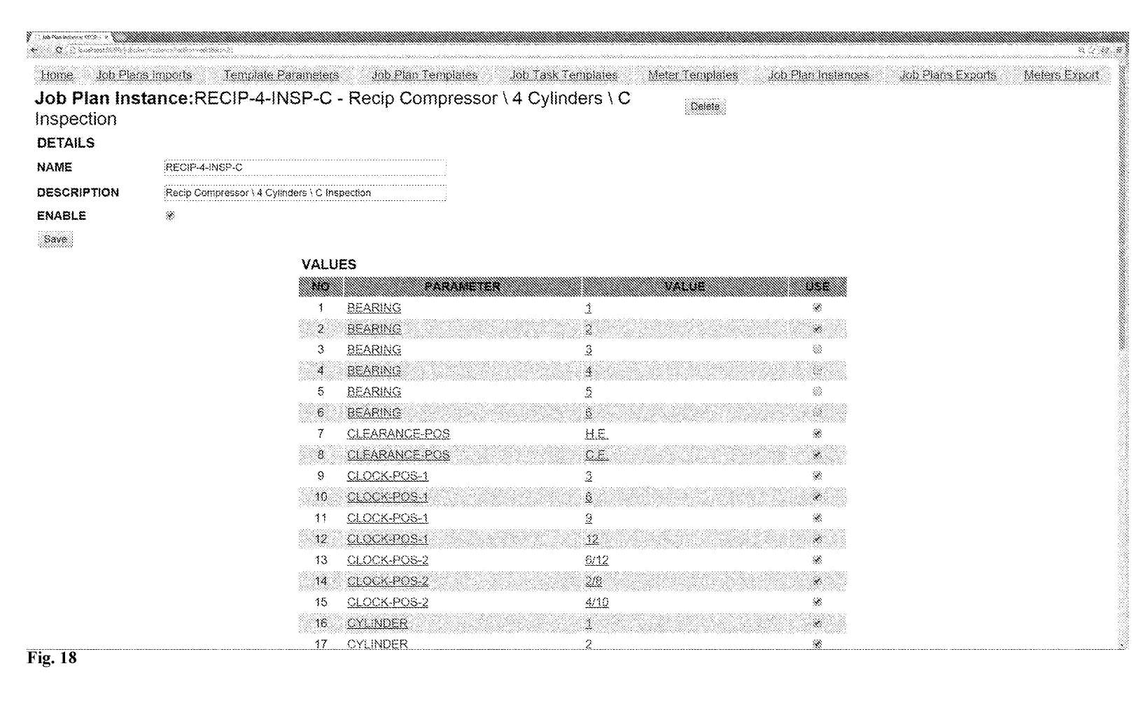

FIG. 19 illustrates a job plan export.

FIG. 20 illustrates a list of meter exports.

FIG. 21 illustrates a job plan export communicated to a work management system.

FIG. 22 illustrates meter exports communicated to a work management system.

FIG. 23 illustrates job plan template with task grouping.

FIG. 24 illustrates a job plan export with repeating task group.

FIG. 25 illustrates a data model used to represent the various templates.

### DETAILED DESCRIPTION

Various features described herein relate to a process for streamlining job plans for a work management system using parameterized templates. The parameterization of job tasks and any ancillary components allows job plans to be consolidated into job plan templates. Various job plan instances can then be configured using such a template, representing the various configurations of a class of asset. The advantage of this approach is reducing the volume of material that must be maintained for potentially mission critical, safety critical job plans. Furthermore, it allows for the generation of fine-grain job plans for the various subclasses of an asset. Ultimately, it enables an organization to shift focus towards developing the best possible job tasks, which are then reused to develop the best possible job plans.

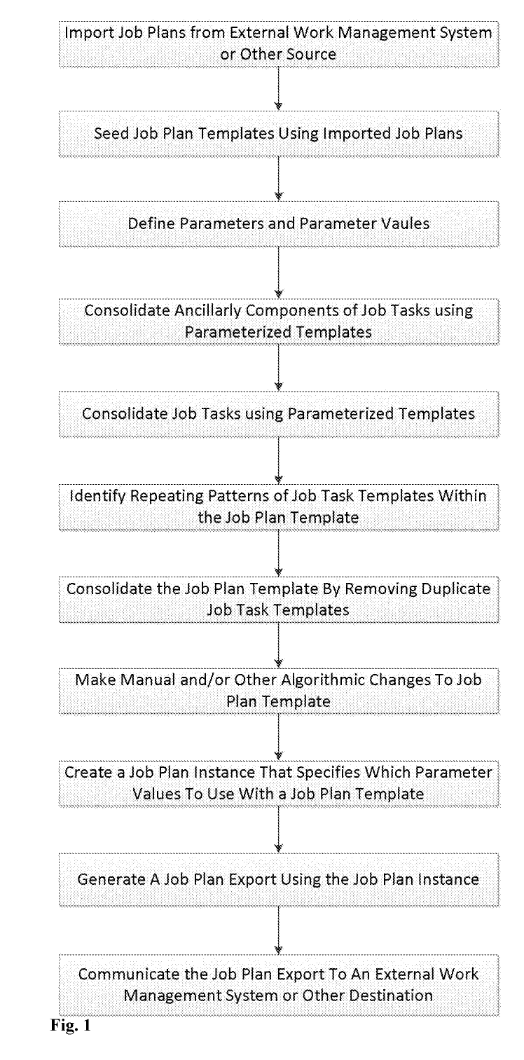

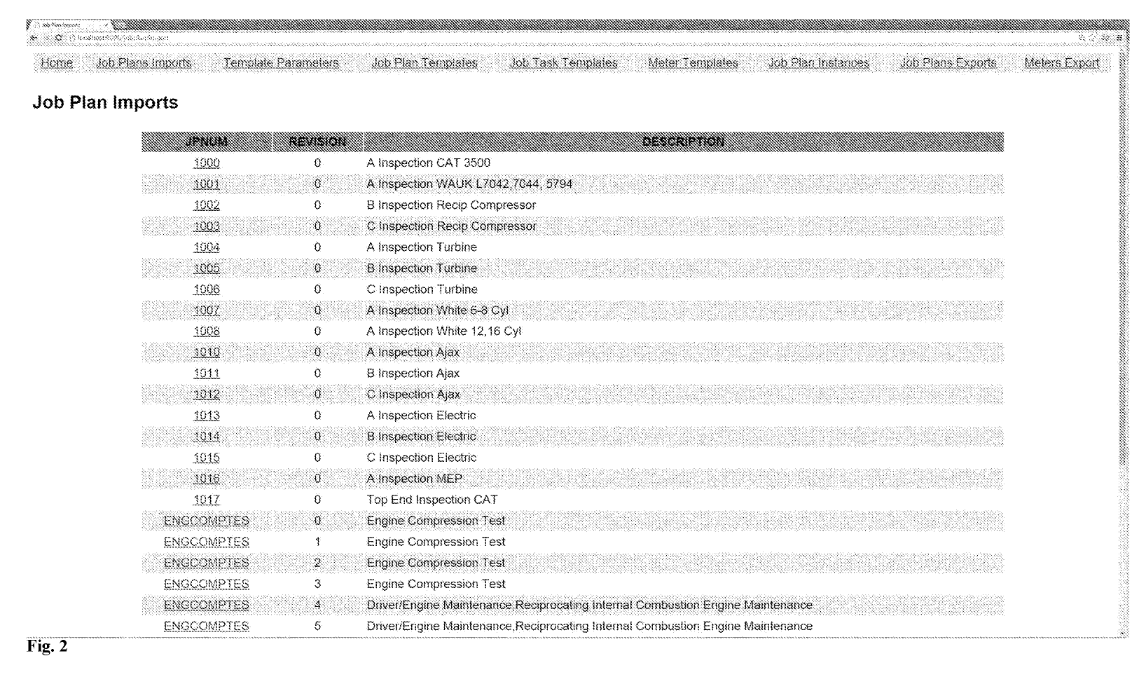

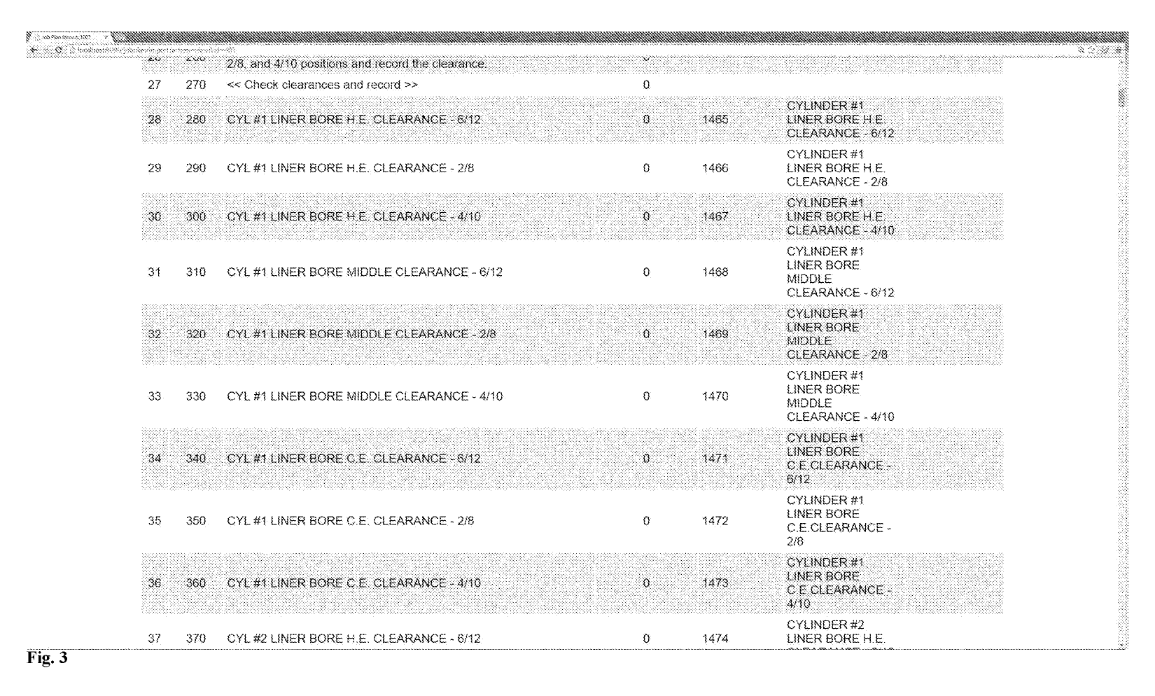

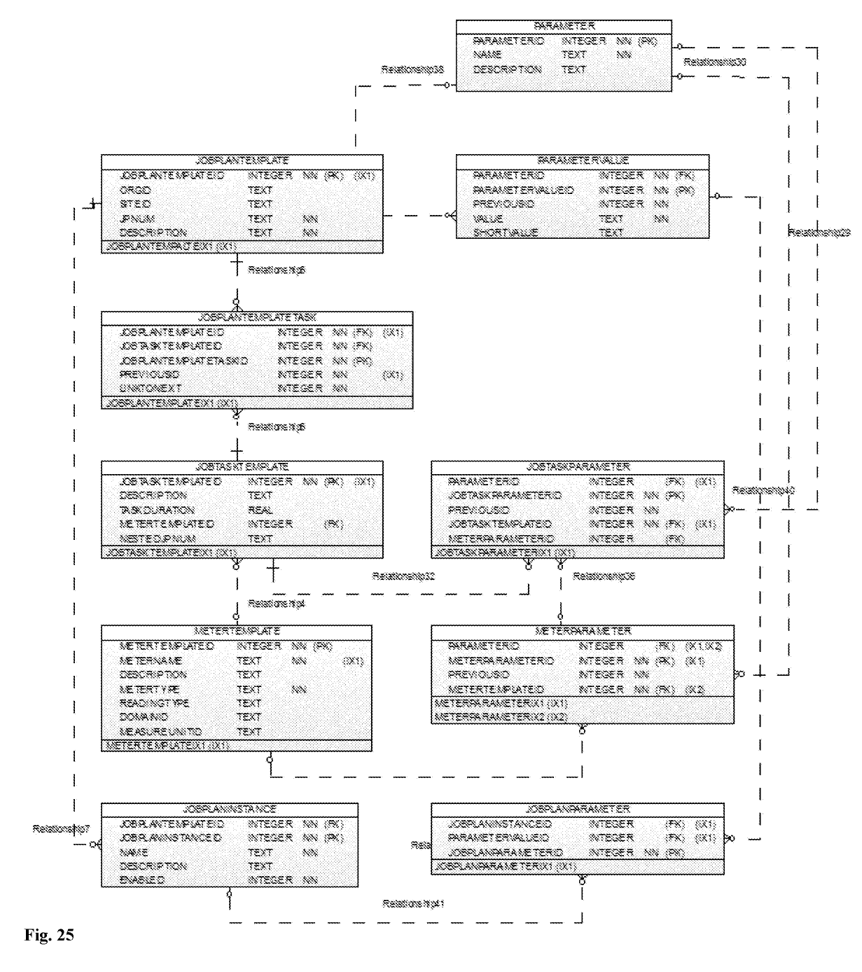

With reference to FIG. 1, the process may begin with the importation of existing job plans from a work management system or other source such as a spreadsheet. These job plan imports are then used to seed the job plan, task and ancillary component templates. FIG. 2 lists job plan imports imported from a work management system and FIG. 3 lists a job plan import and underlying tasks that will be consolidated into templates. A data model such as that shown in FIG. 25 may be used to represent these templates. The data model of FIG. 25 demonstrates how the structure of templates can be setup for job task template reuse within and across multiple job plan templates, and ancillary component reuse across job task templates.

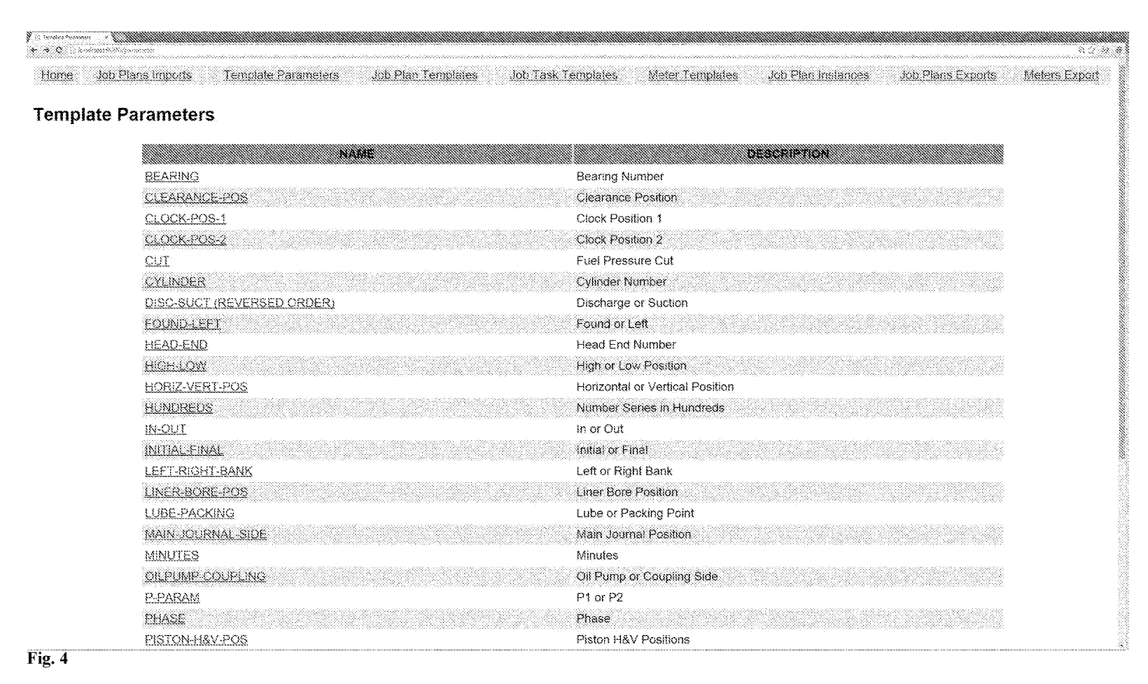

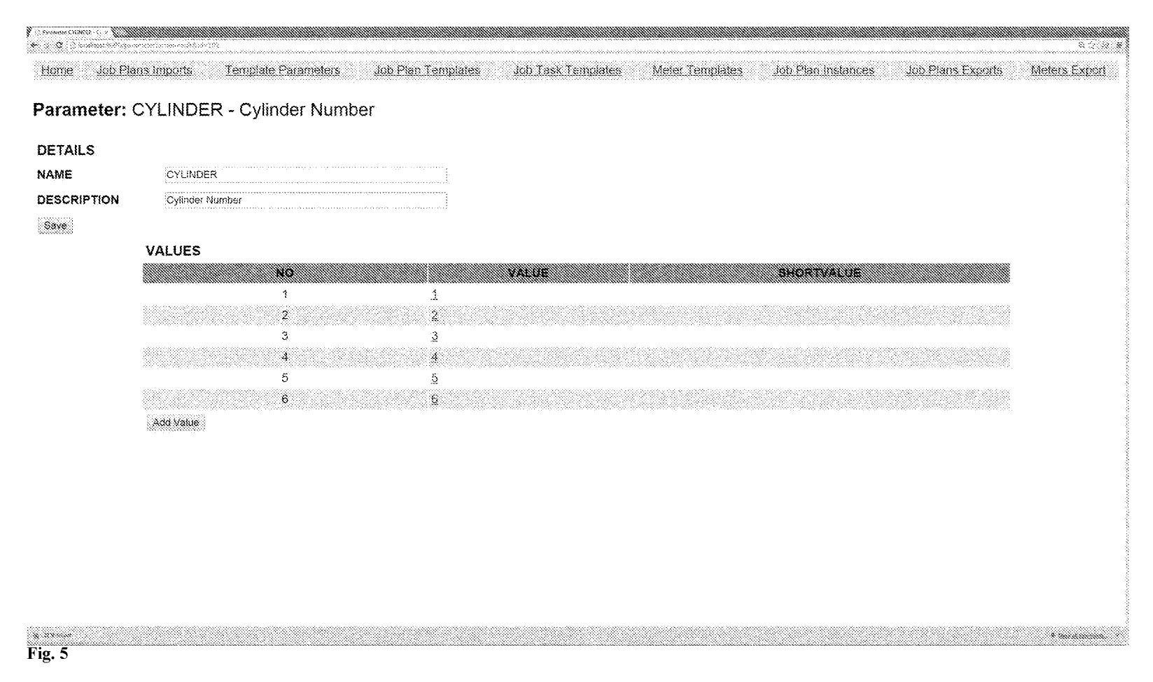

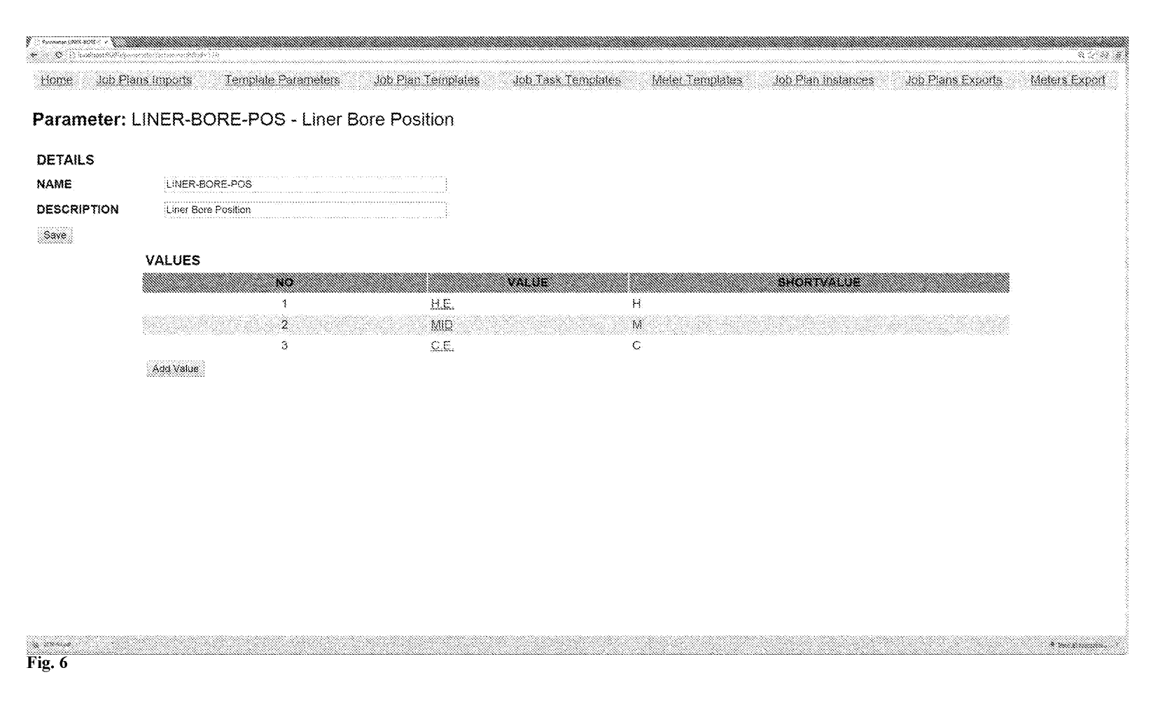

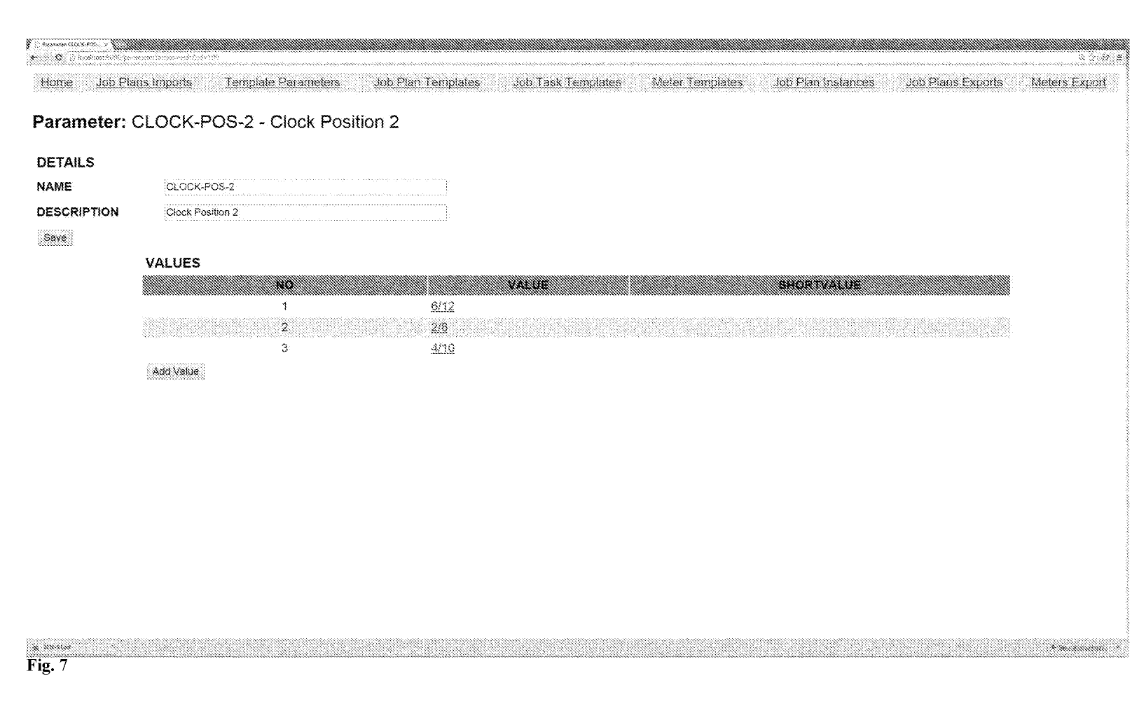

In order to properly setup the various templates, parameters and parameter values must be configured. FIG. 4 shows a list of parameters. FIGS. 5, 6, and 7 show parameters and parameter values. A parameter may be configured with values and optional short values for each value. Short values are used when generating the identifiers of ancillary components, which are often condensed.

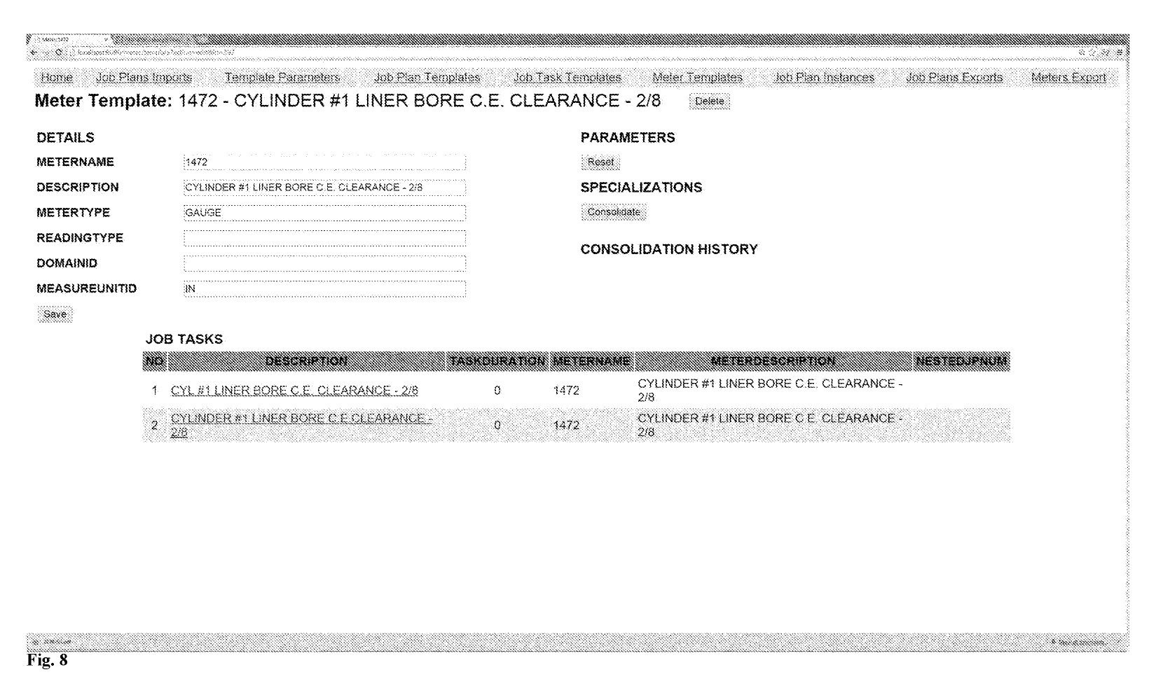

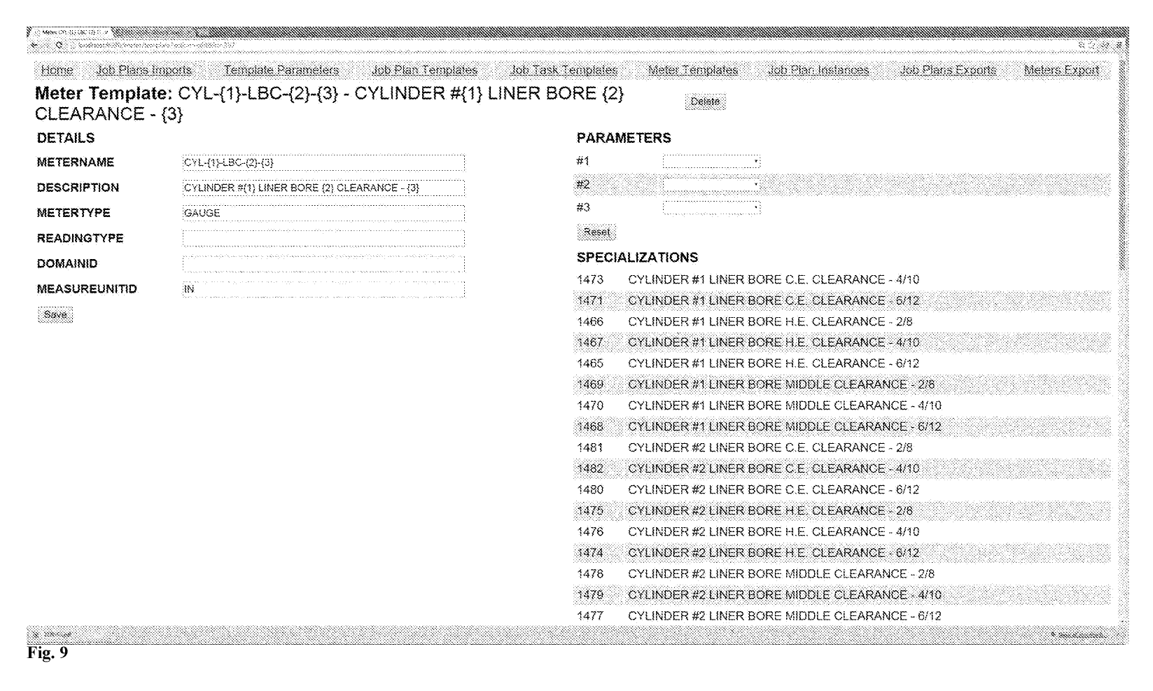

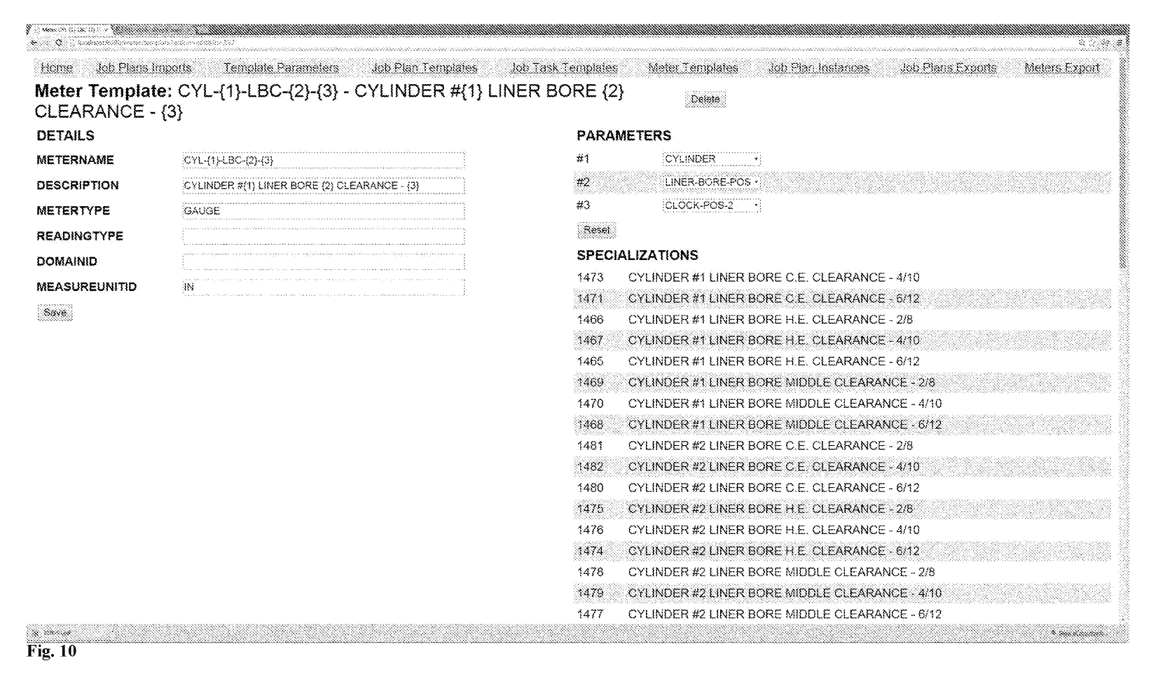

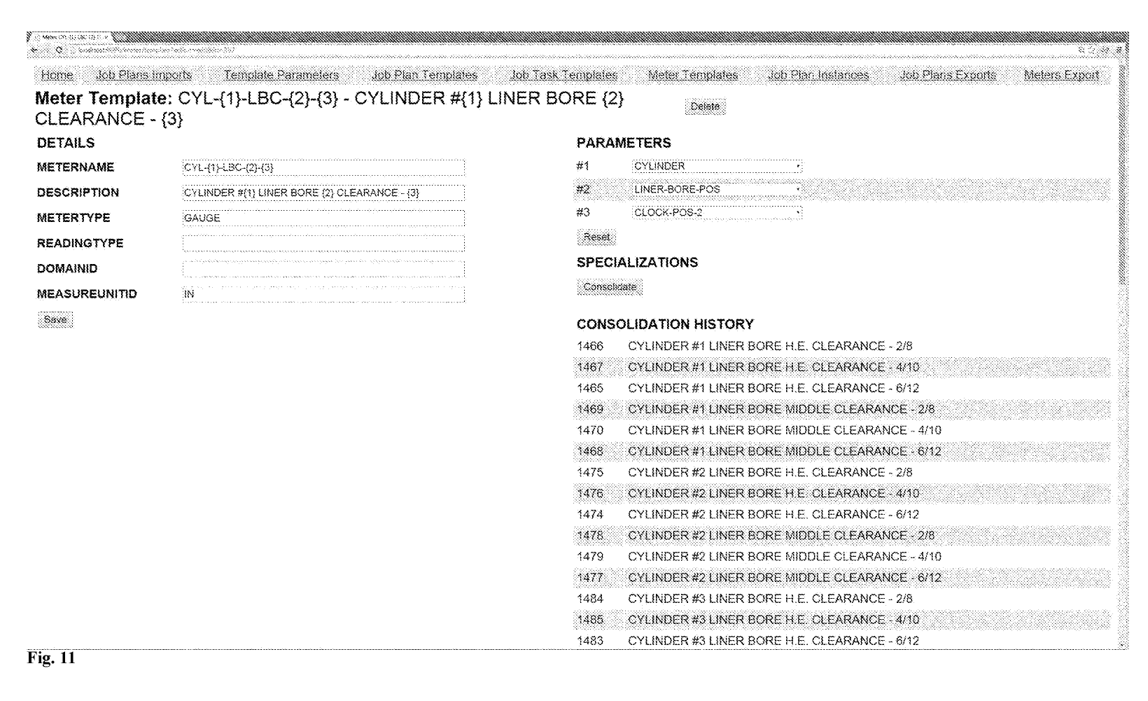

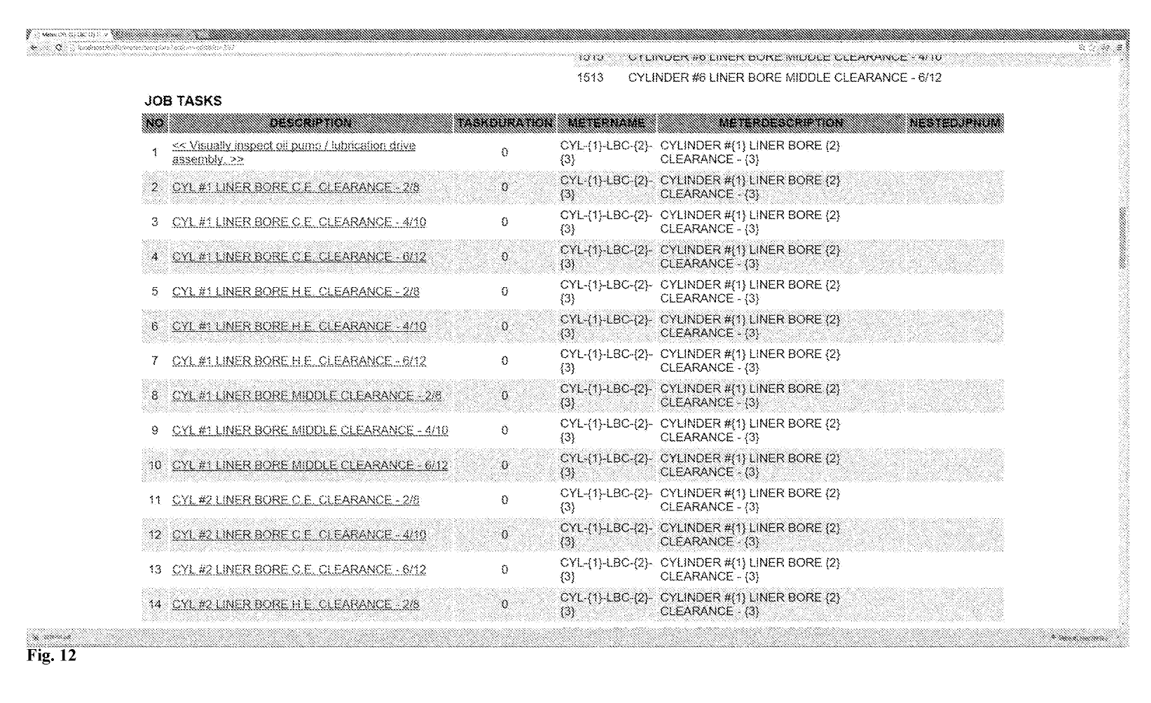

After configuring parameter and parameter values, the process then moves to the consolidation of ancillary components. FIG. 8 shows an unconsolidated meter template. FIG. 9 shows the same meter template after parameter placeholders have been created. The specializations captured by the template are now identifiable. FIG. 10 shows the same meter template after parameters have been assigned to the parameter placeholders. FIG. 11 shows the same meter template after the specializations have been consolidated. This last consolidation step replaces the specializations with the template across all the seeded job task templates and removes the other specializations as templates. FIG. 12 shows how the consolidated meter template is now leveraged across multiple job task templates.

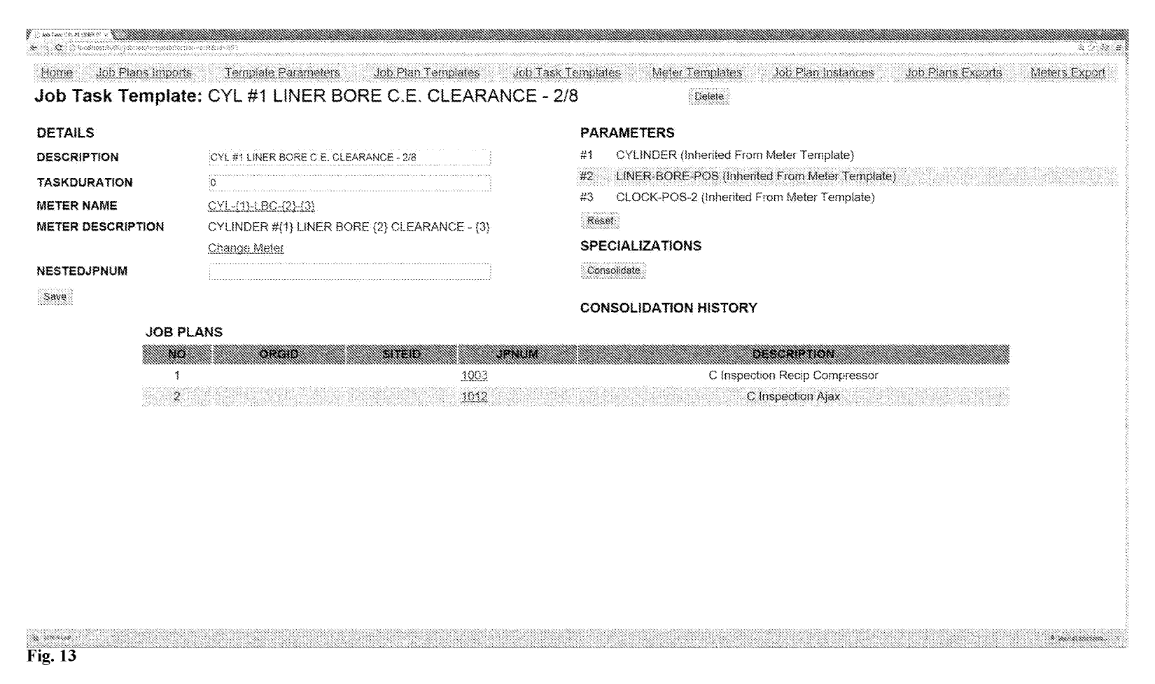

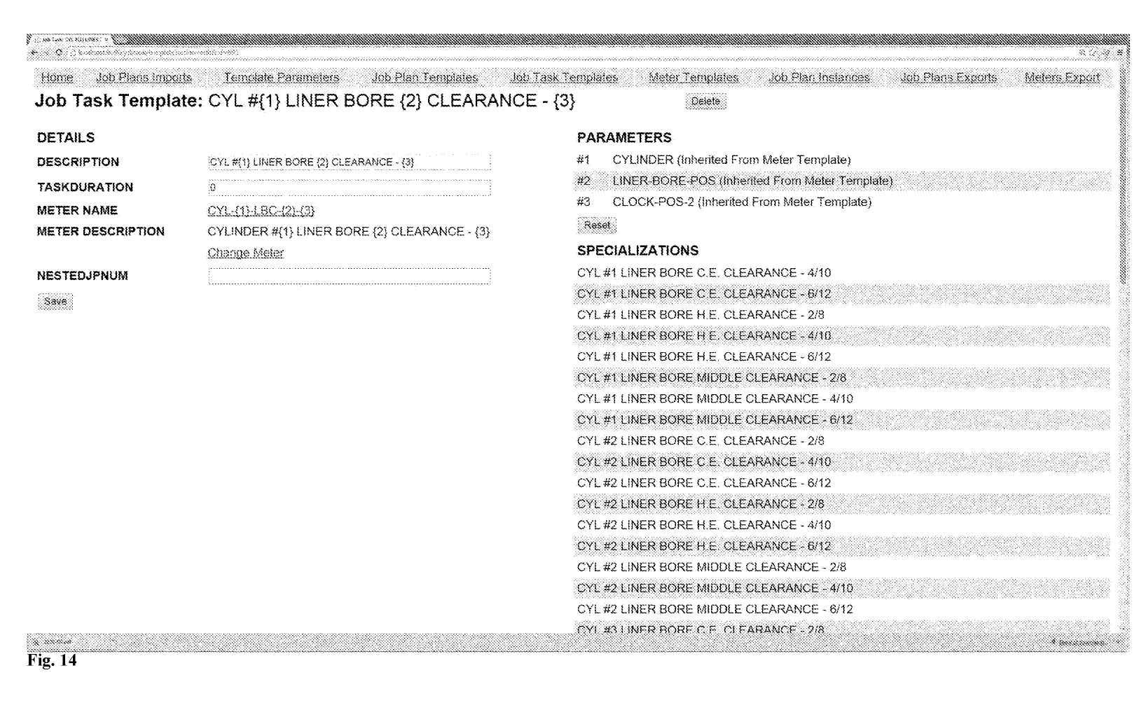

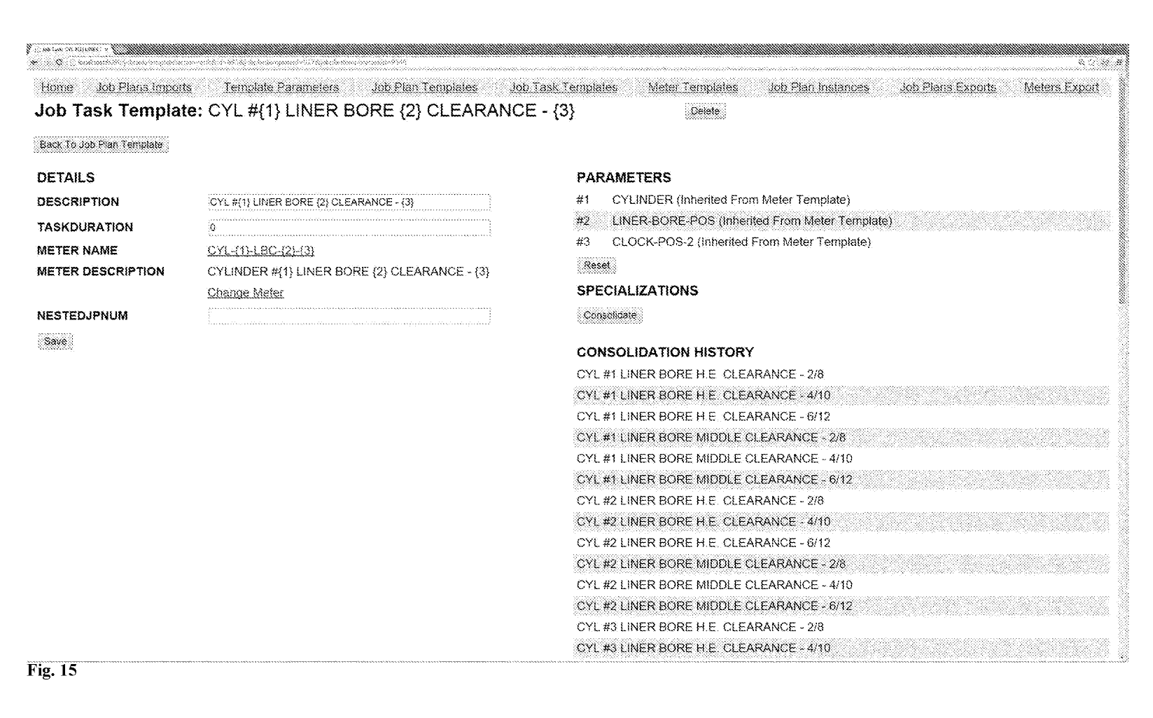

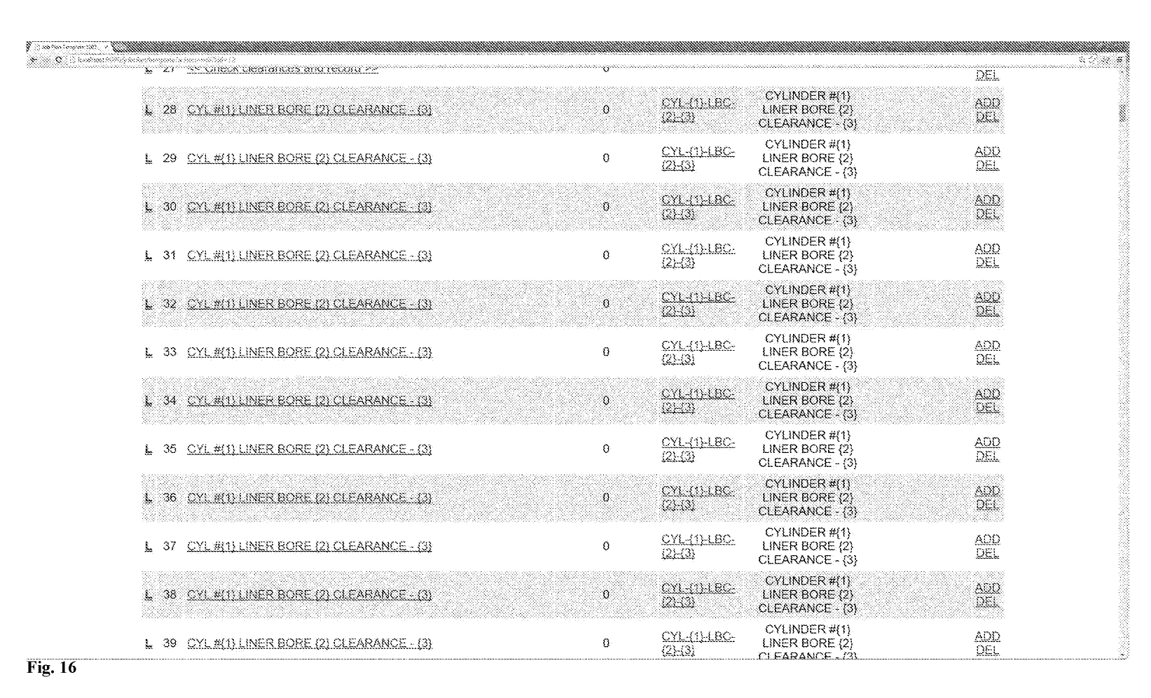

After consolidating the ancillary components, the process then moves to the consolidation of job tasks. FIG. 13 shows an unconsolidated job task template. FIG. 14 shows that same meter template after parameter placeholders have been created. Parameters may either be inherited from the ancillary tasks or assigned at the job task level. The specializations captured by the template are now identifiable. FIG. 15 shows the same job task template after the specializations have been consolidated. This last consolidation step replaces the specializations with the template across all the seeded job plan templates and removes the other specializations as templates. FIG. 16 shows how the consolidated job task template is now leveraged in-place of the specializations on a job plan template.

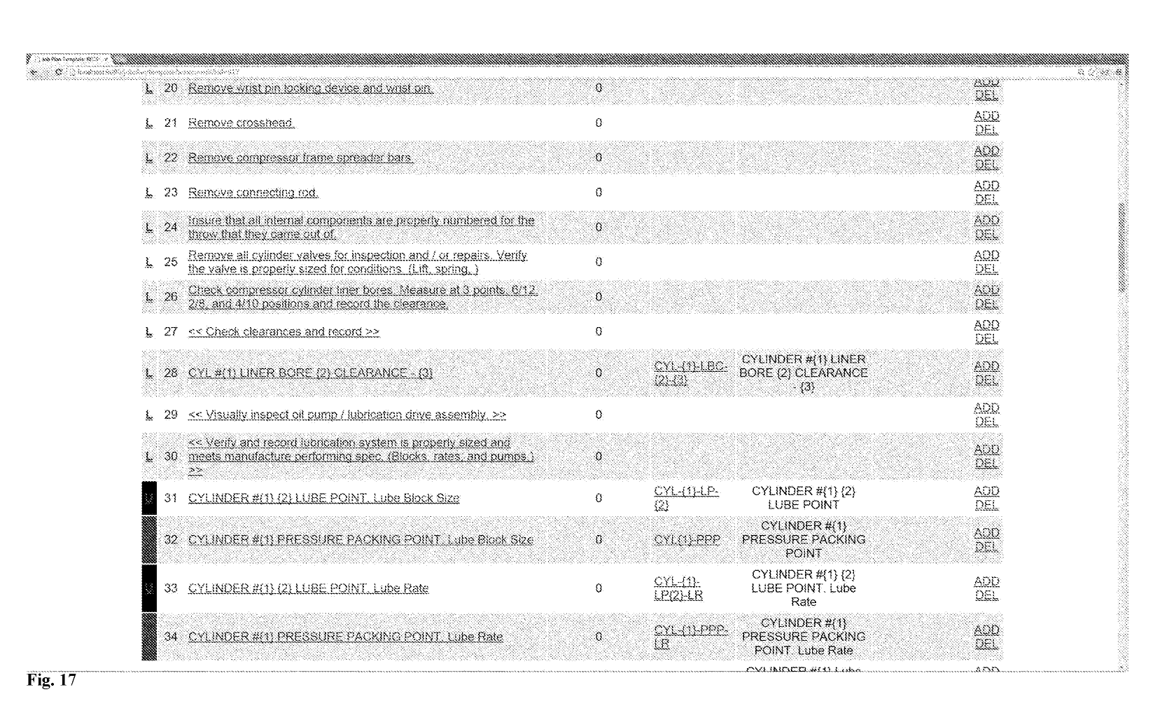

After consolidating the job tasks, the process then moves to the consolidation of the job plans. FIG. 17 shows how duplicate job task templates created through the consolidation process are removed. Line 28 now represents all the job tasks and ancillary components shown by the specializations in previous figures. Lines 31 through 34 show other job task templates which were identified as a repeating pattern, linked and consolidated.

After consolidating the job plans, the process then moves to setting up a job plan instance using a job plan template. Here the parameters values to be used in the generation process are selected. Other configuration information pertinent to the generation process would be set here, such as linking nested job plans found with the job plan template to other job plan instances.

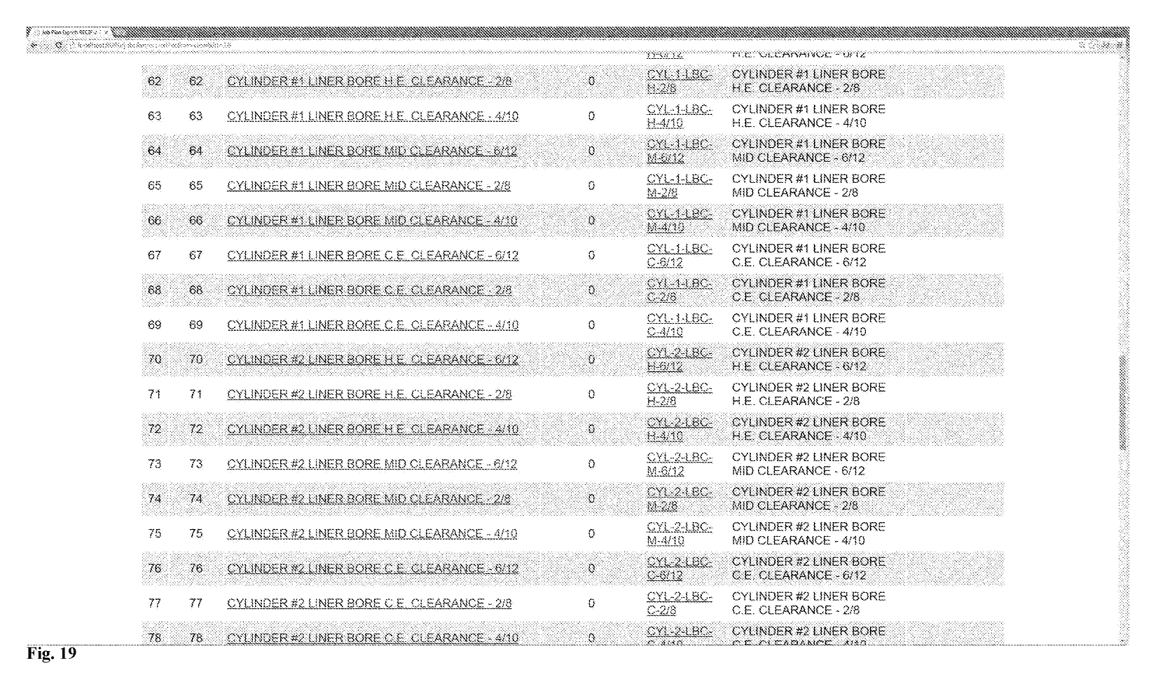

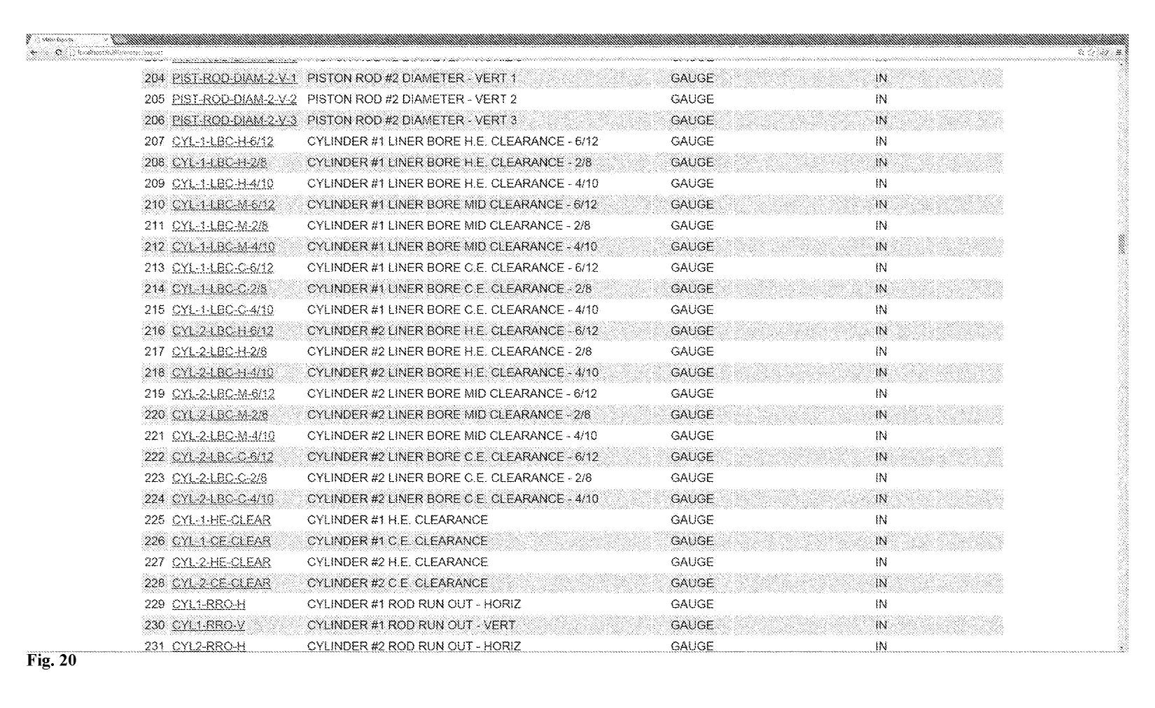

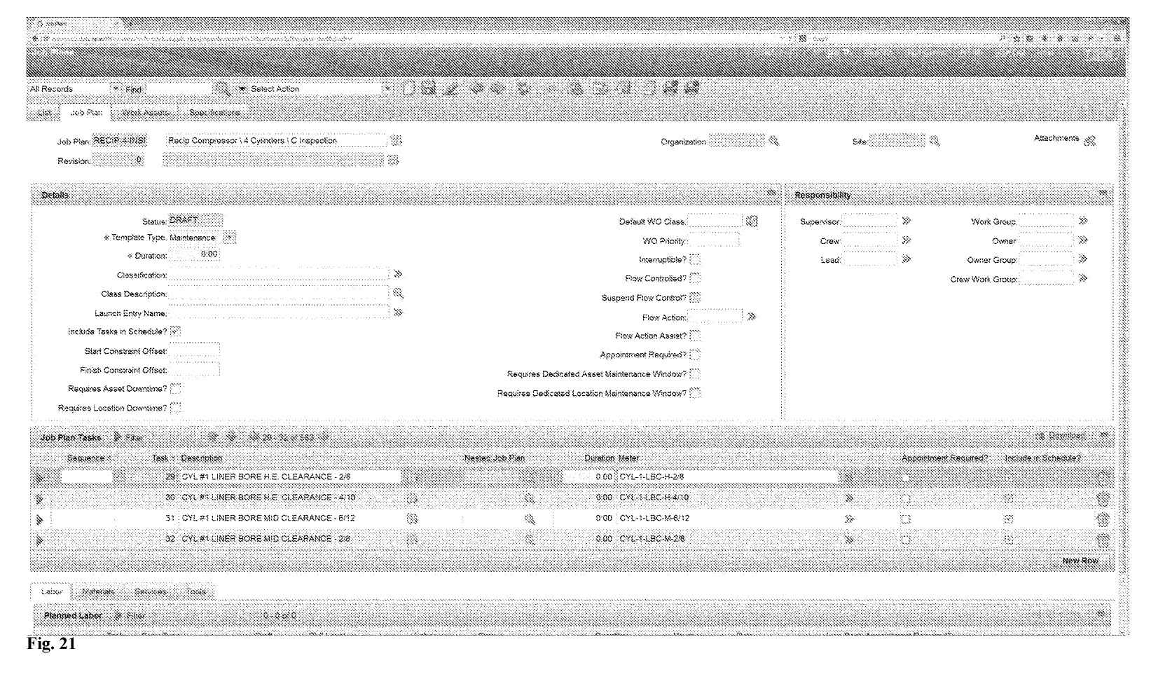

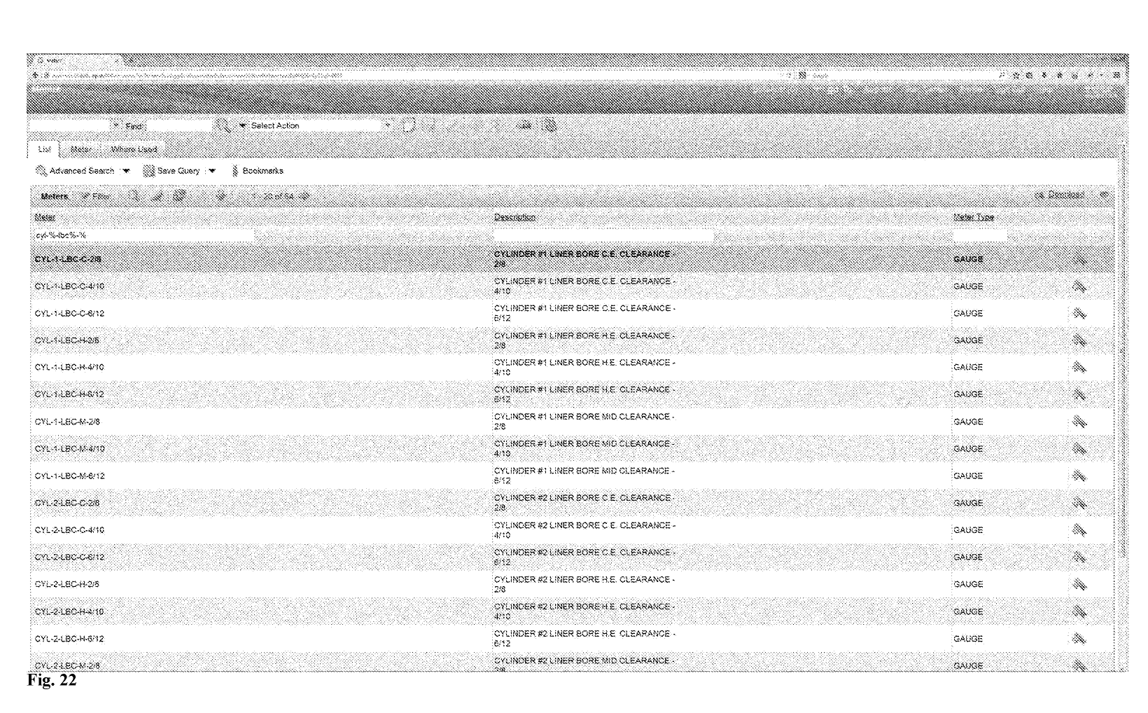

After configuring a job plan instance, the process then moves to generating a job plan export, which is then transmitted to the work management system. FIG. 19 shows a job plan export. FIG. 20 shows supporting ancillary components exports that were generated. FIG. 21 shows the same job plan export that has been communicated to a work management system. FIG. 22 shows the supporting ancillary components communicated to the work management system as well.

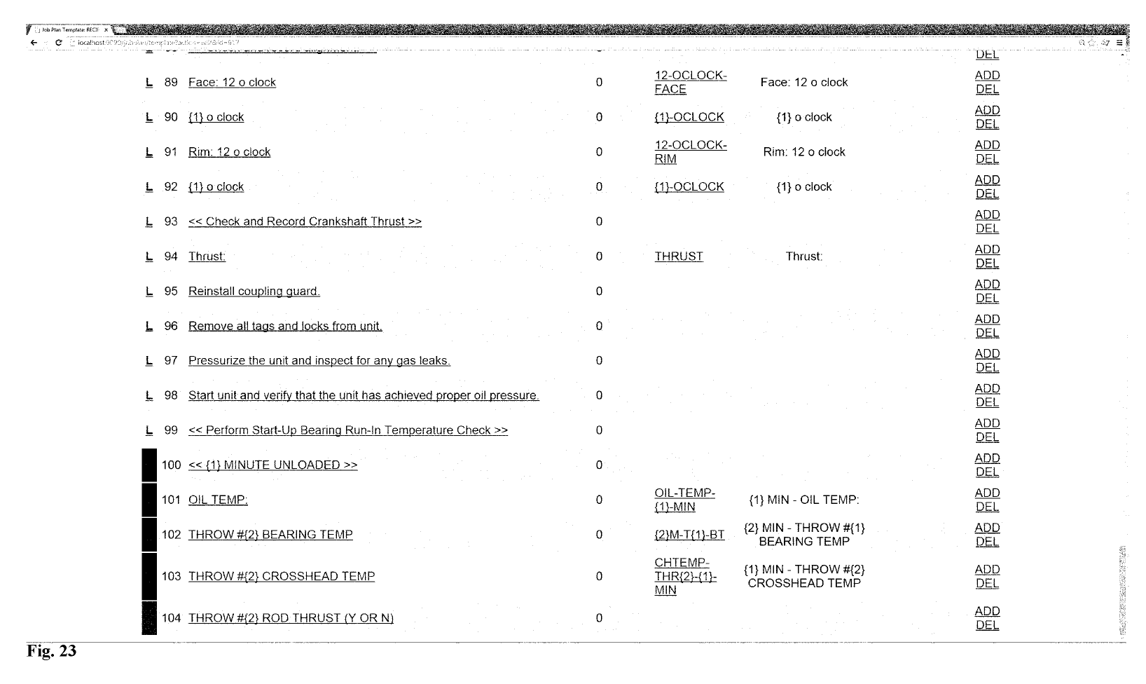

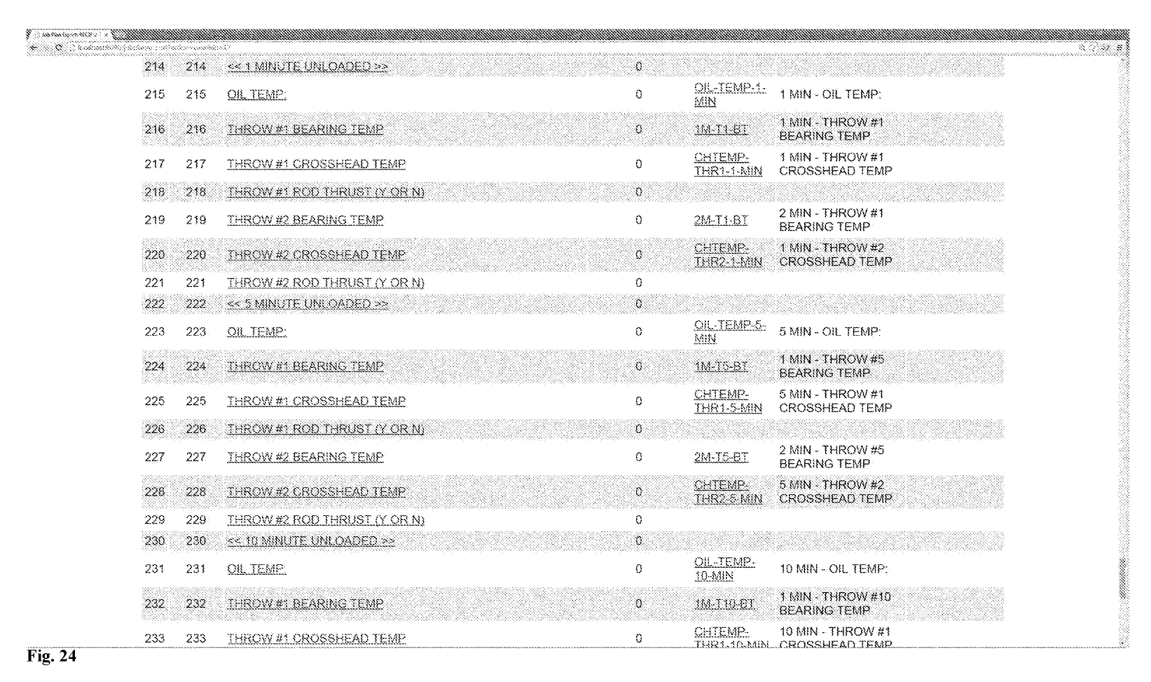

In reference to FIG. 23, a job plan template may be composed of complex job task template groupings. For instance, a group of tasks may all share a common group of parameters and need to be executed in sequence for each distinct set of parameter values. Lines 100 through 104 show such a grouping. All tasks share the MINUTES parameter. The generation process leverages the linkage information set within the representation and generates the tasks in repeating groups based on the MINUTES parameter values, as show in FIG. 24.

The process was implemented external to a work management system, but could similarly be implemented within a work management system.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### CITATIONS

Carruth, J. S. (2011, Jan. 13). Method and system for project management. Retrieved from http://www.google.com/patents/US20110010214
Cox, S. M., Janakiraman, J., Lu, F., & Salem, L. F. (2013, May 2). Smart Task Tracking Retrieved from http://www.google.com/patents/US20130111480
Kay, S. T. S. (2012, Sep. 6). Project management system and template. Retrieved from http://www.google.com/patents/US20120226617

The invention is claimed:

1. A process that consolidates job plans into job plan templates, comprising: creating job task templates by replacing the variable components of otherwise identical tasks with placeholders representing parameters, then representing all or a portion of the job tasks captured by the job task template within the job plan, effectively forming a job plan template.
a. The process of claim 1, further comprising any ancillary component of the job task; including without limitation to meters, nested job plans, lockouts, tag outs, and required tools.
b. The process of claim 1, further comprising the algorithmic removal of duplicate job task templates from the job plan template.
c. The process of claim 1, further comprising the algorithmic grouping of related job task templates within the scope of a job plan template, including without limitation to repeating patterns of job task templates involving one or more common parameters.
d. The process of claim 1, further comprising the capture of variable components for later reuse.
e. The process of claim 1, further comprising the use of an algorithm to identify variable components.
f. The process of claim 1, further comprising the use of rules in the substitution a variable component with a parameter placeholder.
g. The process of claim 1, further comprising the importation of data to initiate the consolidation process.

2. The representation of a job plan template as a composition of job task templates as defined in claim 1.
a. The representation of claim 2, further comprising the reuse of a job task template across multiple job plans templates.
b. The representation of claim 2, further comprising the inheritance of a job task template or templates from another job plan template or templates.
c. The representation of claim 2, further comprising the linkage of job task templates into groups within the scope of a job plan template.
d. The representation of claim 2, further comprising the inclusion of job task templates having no parameters.
e. The representation of claim 2, further comprising the reuse of ancillary components across multiple job task templates.
f. The representation of claim 2, further comprising the ability to inherit parameters from ancillary components on job task templates.
g. The representation of claim 2, further comprising the representation of which job plans utilize a job task template.
h. The representation of claim 2, further comprising the representation of which job task templates utilize an ancillary component.
i. The representation of claim 2, further comprising a hierarchical view of job plan, task or ancillary component templates.
j. The representation of claim 2, further comprising the usage of language translations.
k. The representation of claim 2, further comprising construction through the consolidation process of claim 1.
l. The representation of claim 2, further comprising construction manually, either in whole or part.
m. The representation of claim 2, further comprising construction via file import.
n. The representation of claim 2, further comprising construction via import from an external source, including without limitation to a service that provides prepared job plan templates.
o. The representation of claim 2, further comprising construction by means of group collaboration.
p. The representation of claim 2, further comprising of the addition, subtraction and/or rearranging of job task templates and/or ancillary components using an algorithm.
q. The representation of claim 2, further comprising of the addition, subtraction and/or rearranging of job task templates and/or ancillary components using rules.

3. A process that generates job plans, comprising: using the job plan template representation of claim 2 combined with parameter values to emit a job plan, tasks and ancillary components in which parameter placeholders are populated with parameter values.
a. The process of claim 3, further consisting of the ability to specify parameter values; including without limitation to a set of parameter values and/or range of parameter values.
b. The process of claim 3, further consisting of an integration with an external system or other internal component that provides parameter values.
c. The process of claim 3, further comprising the ability to define a value and optional short value for a parameter.
d. The process of claim 3, further consisting of the iteration of parameter values when emitting job tasks and/or ancillary components.
e. The process of claim 3, further consisting of the ability to leave parameters unspecified and signal that a task or group of tasks should be skipped.
f. The process of claim 3, the incorporation of additional configuration information relevant to the generation process; including without limitation to the assignment of another job plan template to a nested job plan found with the current job plan template.
g. The process of claim 3, further consisting the generation of patterns of job task templates based upon the linkage found in the representation of claim 2.
h. The process of claim 3, further consisting of narrowing, broadening or rearranging the job plan tasks and/or ancillary components either during and/or following completion of the generation process using an algorithm.
i. The process of claim 3, further consisting of narrowing, broadening and/or rearranging the job plan tasks and/or ancillary components either during and/or following completion of the generation process using rules.
j. The process of claim 3, further consisting of the export of generated job plans to an external system.
k. The process of claim 3, further consisting of the inclusion of revision control that tracks changes.
